(19) United States
(12) Patent Application Publication
(10) Pub. No.: US 2008/0139977 A1
(43) Pub. Date: Jun. 12, 2008

(54) NON-INVASIVE METHODS FOR VIBRATIONAL TREATMENT OF BONE TISSUE FOLLOWING A BONE-RELATED MEDICAL PROCEDURE

(75) Inventors: Roger J. Talish, Hillsborough, NJ (US); Clinton T. Rubin, Port Jefferson, NY (US); Kenneth J. McLeod, Vestal, NY (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: Juvent. Inc., Somerset, NJ (US)

(21) Appl. No.: 11/950,368

(22) Filed: Dec. 4, 2007

Related U.S. Application Data
(60) Provisional application No. 60/873,327, filed on Dec. 7, 2006.

(51) Int. Cl. A61H 1/00

(52) U.S. Cl. 601/46; 601/49; 601/51

(57) ABSTRACT

Non-invasive methods for treating bone tissue using vibrations or vibratory energy. The bone tissue may have undergone a bone-related medical procedure prior to providing the vibrational treatment.

### CROSS-REFERENCE TO RELATED PATENTS

The present application is related to U.S. Pat. Nos. 6,607,497, 6,843,776 and 6,884,227, the contents of which are hereby incorporated by reference.

### PRIORITY

This application claims priority to a provisional application filed on Dec. 7, 2006 titled “Non-invasive Apparatuses and Methods for Vibrational Treatment of Bone Tissue Following a Bone-related Medical Procedure,” and assigned U.S. Provisional Application Ser. No. 60/873,327; the entire contents of which are hereby incorporated by reference.

### BACKGROUND

1. Technical Field

The present disclosure relates to non-invasive bone treatment methods following a bone-related medical procedure. The bone-related medical procedure can be performed due to a musculoskeletal-related injury, bone-related condition, such as osteoporosis; and other reasons. Several bone-related medical procedures include a procedure which entails providing a synthetic bone graft material or bone void filler to influence or facilitate bone ingrowth; a procedure which entails stabilizing a bone fracture by inserting pins through the skin and the bone; a procedure which entails using external fixators for limb shaping, e.g., limb lengthening (distraction osteogenesis) or limb straightening; a procedure which entails attaching a limb; a procedure which entails providing the patient with a cast, such as providing the patient with a cast surrounding a portion of a limb or an entire body cast; and joint fusion, a procedure which entails permanently fusing bones, such as in the case of an unnatural fracture of the ankle and spinal fusion procedures using spinal cages.

2. Description of the Related Art

A method of using resonant vibrations for treating postural instability is described in U.S. Pat. No. 6,607,497. The method includes the steps of (a) providing a vibration table having a non-rigidly supported platform; (b) permitting the patient to rest on the non-rigidly supported platform for a predetermined period of time; and (c) repeating the steps (a) and (b) over a predetermined treatment duration. Step (b) includes the steps of (b1) measuring a vibrational response of the patient's musculoskeletal system using a vibration measurement device; (b2) performing a frequency decomposition of the vibrational response to quantify the vibrational response into specific vibrational spectra; and (b3) analyzing the vibrational spectra to evaluate at least postural stability.

The method described in U.S. Pat. No. 6,607,497 entails the patient standing on the vibration table or unstable standing platform which includes at least one accelerometer mounted to the outboard side thereof. The patient is then exposed to a vibrational stimulus by the unstable standing platform. The unstable standing platform causes a vibrational perturbation of the patient's neuro-sensory control system. The vibrational perturbation causes signals to be generated within at least one of the patient's muscles to create a measurable response from the musculoskeletal system. These steps are repeated over a predetermined treatment duration for approximately ten minutes a day in an effort to improve the postural stability of the patient.

### SUMMARY

In accordance with the present disclosure, non-invasive methods are described for vibrational treatment of bone tissue following a bone-related medical procedure. The vibrational treatment entails using resonant vibrations or a vibrational stimulus produced by a vibration table similar to the vibration table described in U.S. Pat. No. 6,607,497. Other vibrational tables or apparatus for creating resonant vibrations for vibrational treatment are described in U.S. patent application filed on Jul. 18, 2006 titled “Vibrational Therapy Assembly for Treating and Preventing the Onset of Deep Venous Thrombosis” and assigned U.S. patent application Ser. No. 11/488,227; U.S. patent application filed on Jul. 17, 2006 titled “Dynamic Motion Therapy Apparatus Having a Treatment Feedback Indicator” and assigned U.S. patent application Ser. No. 11/487,677; U.S. patent application filed on Mar. 24, 2006 titled “Apparatus and Method for Monitoring and Controlling the Transmissibility of Mechanical Vibration Energy During Dynamic Motion Therapy” and assigned U.S. patent application Ser. No. 11/388,286; and U.S. patent application filed on Mar. 6, 2006 titled “Supplemental Support Structures Adapted to Receive a Non-invasive Dynamic Motion Therapy Device” and assigned U.S. patent application Ser. No. 11/369,611; the entire contents of these U.S. patent applications are incorporated herein by reference.

The vibrational treatment is also known as dynamic motion therapy and its effects on the musculoskeletal system are described at www.juvent.com.

Several bone-related medical procedures which the apparatus and methods described herein can be used following the performance thereof include a procedure which entails providing a synthetic bone graft material or bone void filler to influence or facilitate bone ingrowth; a procedure which entails stabilizing a bone fracture by inserting pins through the skin and the bone; a procedure which entails using external fixators for limb lengthening (distraction osteogenesis) and/or limb straightening; a procedure which entails attaching a limb; a procedure which entails providing the patient with a cast, such as providing the patient with a cast surrounding a portion of a limb or an entire body cast; and joint fusion, a procedure which entails permanently fusing bones, such as in the case of an unnatural fracture of the ankle and spinal fusion procedures using spinal cages. The non-invasive vibrational treatment apparatuses and methods can also be used following other bone-related medical procedures which are not listed above.

### BRIEF DESCRIPTION OF THE DRAWINGS

FIG. 1 is a perspective view showing a vibrating platform with a patient undergoing vibrational treatment for treating bone tissue following a bone-related medical procedure in accordance with the method of the present disclosure;

FIG. 2 is a flow diagram showing the steps of a method for treating bone tissue following a bone-related medical procedure in accordance with the method of the present disclosure;

FIG. 3 is a perspective view showing a vibrating platform with a patient undergoing vibrational treatment for treating bone tissue following a bone-related medical procedure, where the patient is also wearing a vibrating apparatus for generating resonant vibrations in proximity to the bone tissue requiring vibrational treatment in accordance with the present disclosure;

FIG. 4 is a flow diagram showing the steps of a method for treating bone tissue following a bone-related medical procedure in accordance with the present disclosure;

FIG. 5 is an isometric view showing a non-mobile patient laying on a vibrational bed for treating bone tissue following a bone-related medical procedure in accordance with the present disclosure; and

FIG. 6 is a perspective view showing a vibrating apparatus strapped on a patient's leg and generating resonant vibrations in proximity to the bone tissue requiring vibrational treatment in accordance with the present disclosure.

### DETAILED DESCRIPTION OF PREFERRED EMBODIMENTS

The present disclosure describes non-invasive methods for vibrational treatment of bone tissue following a bone-related medical procedure. The methods according to the present disclosure are typically employed following a determination that vibrational treatment of a patient's bone tissue following a bone-related medical procedure would produce a beneficial result.

Several bone-related medical procedures which the apparatus and methods described herein can be used following the performance thereof include a procedure which entails providing a synthetic bone graft material or bone void filler to influence or facilitate bone ingrowth (see Walsh, W. R., et al., “Influence of Dynamic Motion Therapy on bone ingrowth into a bone graft substitute” which is submitted herewith and whose entire disclosure, including photographs, is a part of this provisional application); a procedure which entails stabilizing a bone fracture by inserting pins through the skin and the bone; a procedure which entails using external fixators for limb lengthening (distraction osteogenesis) and/or limb straightening; a procedure which entails attaching a limb; a procedure which entails providing the patient with a cast, such as providing the patient with a cast surrounding a portion of a limb or an entire body cast; and joint fusion, a procedure which entails permanently fusing bones, such as in the case of an unnatural fracture of the ankle and spinal fusion procedures using spinal cages. The non-invasive vibrational treatment apparatus and method can also be used following other bone-related medical procedures which are not listed above.

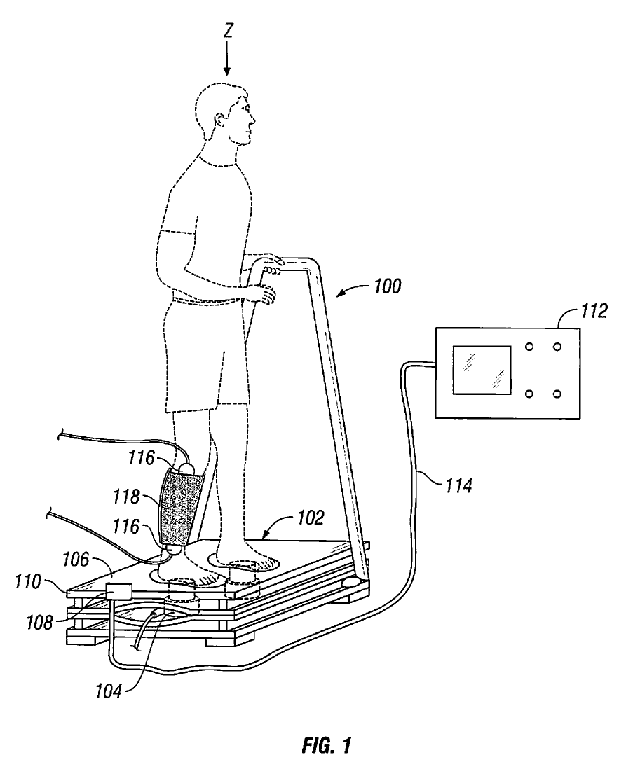

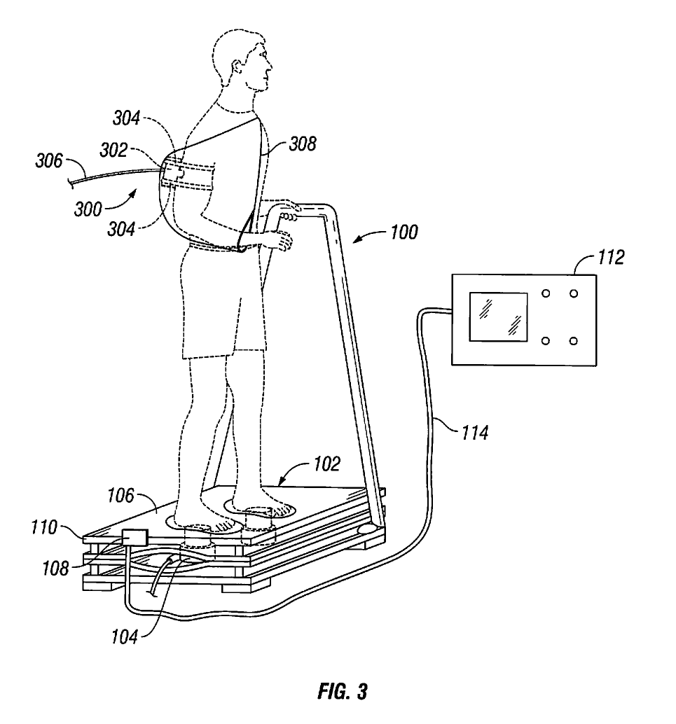

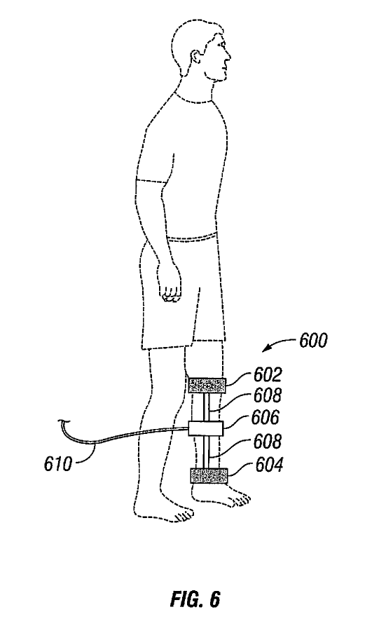

The resonant vibrations or vibrational stimulus produced by a vibration table or bed and transmitted/applied to the bone tissue through the patient's musculoskeletal system (FIGS. 1, 3 and 5) and/or vibratory energy generated by at least one energy moving device (e.g., speakers, air moving devices (blowers and fans) and sub-woofers) and focused on the patient's bone tissue (FIGS. 3 and 6) facilitate a healing response in the bone tissue.

An exemplary apparatus of the present disclosure in accordance with an embodiment of the present disclosure is shown by FIG. 1 and designated generally by reference numeral 100. The apparatus 100 includes a vibration table 102 configured to vibrate for subjecting the musculoskeletal system, including the bone tissue requiring treatment following a bone-related medical procedure, to a vibrational stimulus while the patient is standing on the vibration table 102. The vibration table 102 preferably vibrates to produce resonant vibrations having a frequency in the range of 1 Hz to 100 KHz, and preferably from 1 Hz to 10 KHz. The resonant vibrations provide the vibrational stimulus at substantially the same frequency to the bone tissue. The vibration table 102 includes a motorized spring system having spring supports for causing the table 102 to vibrate at a controlled frequency.

The vibration table 102 imposes vertical vibration on the patient standing thereon. Vibrational treatment is preferably performed at a predetermined frequency for a predetermined period of time and for a predetermined treatment duration depending on one or more parameters. The parameters include the type of bone tissue requiring vibrational treatment, the location of the bone tissue, factors relating to the patient (age, sex, weight, postural stability, etc.), whether the patient has any abnormalities, and/or the condition of the patient and/or bone tissue (stiffness, brittleness, etc.) requiring vibrational treatment. Generally, the predetermined frequency is 30 Hz, the predetermined period of time is ten minutes and the predetermined treatment duration is approximately four weeks.

FIG. 1 shows a patient undergoing the treatment method according to the present disclosure. The bone tissue requiring treatment is located within the patient's right leg, i.e., the bone tissue of the right tibia. The patient has undergone a medical procedure following breakage of the tibia and has been provided with a cast 118.

During treatment according to the method of the present disclosure, the patient stands on the vibration table 102. Vibrations, generated by table 102 for a predetermined period of time, for example, ten minutes, are transmitted through the patient's body and to the bone tissue of the right tibia which requires vibrational treatment. The vibrations are generated by motorized spring mechanisms 104 located underneath a standing platform 106 of the vibration table 102 and attached thereto. It is contemplated that the vibrations may be generated by a plurality of non-motorized springs or coils attached underneath the standing platform 106, upon which the standing platform 106 rests.

The frequencies imparted by vibration table 102 are in the range between 30-90 Hz with a peak amplitude between 0.04 and 0.4 g. Preferably, the frequency of the vibration table 102 is approximately 30 Hz and the peak amplitude is 0.3 g. The vibration waves are preferably sinusoidal, however other waveforms are contemplated. The energy propagated by the vibration waves is primarily directed along the Z-axis of the body as shown by FIG. 1.

At least one low-mass accelerometer 108 is mounted to the vibration table 102 on an outboard side 110 of the standing platform 106 as described in U.S. Pat. No. 6,607,497, the contents of which are incorporated herein by reference. Accelerometer 108 is used to measure the vibrational response of the patient's musculoskeletal system to simultaneously determine postural stability of the patient, if so desired, using the method described in U.S. Pat. No. 6,607,497, while providing vibrational treatment to the bone tissue in accordance with the present disclosure.

As described in U.S. Pat. No. 6,607,497, the vibrational response is measured and recorded by a spectrum analyzer/computer 112 which is electrically connected to the accelerometer 108 by a cable 114. The accelerometer response data is analyzed to extract information on postural sway. Preferably, the accelerometer 108 records the individual's natural sway pattern while the individual preferably stands in the Romberg position (feet separated at shoulder width, hands at side, and eyes open) for a preferable period of 10-100 seconds. If the accelerometer 108 is attached to the patient, then one can also analyze and extract information on muscle strength and the muscle to bone stimulus to determine any improvement in the patient's neuro-muscular status.

The method of the present disclosure using the vibrational table 102 shown by FIG. 1 includes the steps of (a) subjecting the patient, including the bone tissue which has undergone a bone-related medical procedure, to a vibrational stimulus for a predetermined period of time; and (b) repeating the step (a) over a predetermined treatment duration to treat the bone tissue. The method further includes the step of having the patient stand on a vibration table capable of vibrating for producing resonant vibrations having a frequency in the range of 1 Hz to 500 Hz. Typically, the resonant vibrations provide the vibrational stimulus at substantially the same frequency to the bone tissue. The vibrational stimulus causes the bone tissue to shake or vibrate at a vibrational frequency for producing a beneficial healing effect. The method also includes the step of evaluating a healing response of the bone tissue. Preferably, the predetermined period of time is approximately ten minutes and the predetermined treatment duration is at least four weeks.

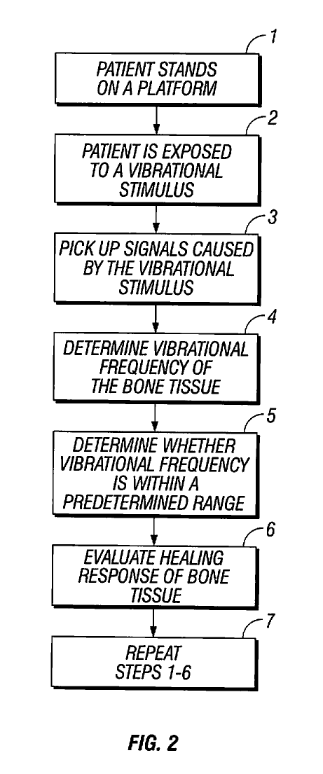

With reference to FIG. 2, there is shown a flow diagram of the vibrational treatment method for treating bone tissue which has undergone a bone-related medical procedure in accordance with the embodiment of the present disclosure described above with reference to FIG. 1. In step 1, the patient stands on a standing platform, such as the standing platform 106 shown by FIG. 1 which may include at least one accelerometer mounted to the outboard side thereof. In step 2, the patient is exposed to a vibrational stimulus by the standing platform 106. In step 3, the vibrational stimulus or perturbation causes signals to be generated within the bone tissue. The signals are preferably picked up by electrical receptors 116 (see FIG. 1) as are known in the art. The electrical receptors are placed on the patient's skin in proximity to the bone tissue.

Preferably, the patient stands on the standing platform for a predetermined period of time, e.g., 10 minutes, and the standing platform 106 is vibrated at approximately 30 Hz and at 0.3 g peak-to-peak.

Step 4 represents measuring/recording the signals picked up by the electrical receptors for recording bone tissue vibrations and determining the vibrational frequency of the bone tissue. Thereafter, in step 5, a determination is made as to whether the vibrational frequency of the bone tissue is within a predetermined range for providing a beneficial response. The determination is made by correlating the vibrational frequency of the bone tissue with data, such as data obtained for individuals with similar characteristics to the patient, for example age, sex, body measurements, etc. Based on the determination, the vibrational frequency of the standing platform 106 is adjusted accordingly or kept constant.

Step 6 provides for evaluating a healing response of the bone tissue to determine if the condition of the bone tissue is improving and/or whether there is bone ingrowth occurring in the case where the bone-related medical procedure is bone grafting (see Walsh, W. R., et al., “Influence of Dynamic Motion Therapy on bone ingrowth into a bone graft substitute” which is submitted herewith and whose entire disclosure, including photographs, is a part of this provisional application). Steps 5 and 6 are preferably performed using a computer running a custom program in order to access data stored within a database and/or data structure, e.g., look-up table, etc., for correlating the vibrational frequency of the bone tissue and evaluating the healing response.

Step 7 entails repeating steps 1-6, where the patient undergoes the procedure over a predetermined treatment duration. Preferably, the treatment duration is at least four weeks which can be adjusted according to the evaluation performed in step 6. Further, the predetermined period of time or the amount of time the patient stands on the platform during each treatment session can be adjusted according to the evaluation of the healing response performed in step 6.

An exemplary non-invasive apparatus of the present disclosure in accordance with another embodiment is shown by FIG. 3 and designated generally by reference numeral 300. The apparatus 300 is shown mounted to a patient for generating and directing vibratory energy to the patient's right arm for vibrational treatment of bone tissue (i.e., the bone tissue of the humerous) while the patient is simultaneously undergoing vibrational treatment for treating the bone tissue using the vibration table 102 of the apparatus 100 described above with reference to FIG. 1. It is contemplated, however, that the apparatus 300 can be used separate and apart from the apparatus 100.

The apparatus 300 includes at least one energy moving device 302 which may be selected from the group consisting of speakers, air moving devices (blowers and fans) and sub-woofers, or combinations thereof. The energy moving device 302 is mounted to the patient using straps 304 and includes a cord 306 for plugging the energy moving device 302 to a power source, such as an AC source (e.g., wall outlet) or a DC source (e.g. control unit powered by a battery).

During vibrational treatment, the energy moving device 302 generates vibratory energy which is focused to the bone tissue requiring vibrational treatment in accordance with the method of the present disclosure. The at least one energy moving device 302 generates waves having a frequency in the range of 1 Hz to 100 KHz, and preferably from 1 Hz to 10 KHz. The waves, as the resonant vibrations described above, provide a vibrational stimulus at substantially the same frequency to the bone tissue being treated.

Similarly to the method described above with reference to FIGS. 1 and 2, vibrational treatment using the at least one energy moving device 302 is preferably performed at a predetermined frequency for a predetermined period of time and for a predetermined treatment duration depending on one or more parameters. The parameters include the type of bone tissue requiring vibrational treatment, the location of the bone tissue, factors relating to the patient (age, sex, weight, postural stability, etc.), whether the patient has any abnormalities, and/or the condition of the patient and/or bone tissue (stiffness, brittleness, etc.) requiring vibrational treatment. Generally, the predetermined frequency is 30 Hz, the predetermined period of time is ten minutes and the predetermined treatment duration is approximately four weeks.

Preferably, the at least one energy moving device 302 includes piezoelectric transducers for generating the low frequency waves for use in the vibrational treatment of bone tissue. In one preferred embodiment, piezoelectric transducers are used which make use of non-linear parametric acoustics as known in the art to facilitate the generation of the low frequency waves. This type of piezoelectric transducers takes advantage of the non-linear properties of the propagation medium.

In a second preferred embodiment, piezoelectric transducers are used which are fabricated using porous ceramic technology to generate the low frequency waves. This type of piezoelectric transducers take advantage of the intrinsic properties of the material used to fabricate the transducers.

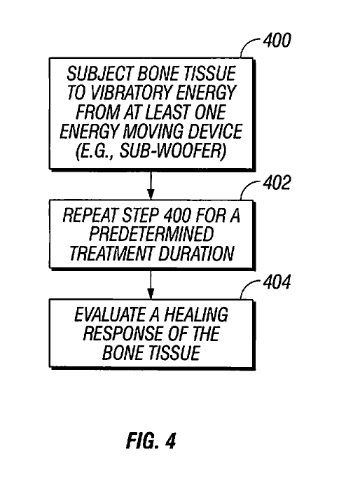

With reference to FIG. 4, the method of the present disclosure includes the steps of (a) subjecting a patient, including the bone tissue which has undergone a bone-related medical procedure, to vibratory energy generated by at least one energy moving device 302 for a predetermined period of time (step 400); and (b) repeating step (a) over a predetermined treatment duration to treat the bone tissue (step 402). The method can further include the step of having the patient stand on the vibration table 102 capable of vibrating for producing resonant vibrations having a frequency in the range of 1 Hz to 100 KHz, and preferably from 1 Hz to 10 KHz, while subjecting the patient to the vibratory energy generated by the at least one energy moving device 302. The resonant vibrations provide a vibrational stimulus at substantially the same frequency to the bone tissue.

The method also includes the step of evaluating a healing response of the bone tissue and adjusting at least one of the predetermined period of time and the predetermined treatment duration accordingly (step 404). In the apparatus and method in accordance with the second embodiment of the present disclosure, the vibrational stimulus provided by the vibratory energy causes the patient and the bone tissue to shake or vibrate for producing a beneficial healing effect for the bone tissue.

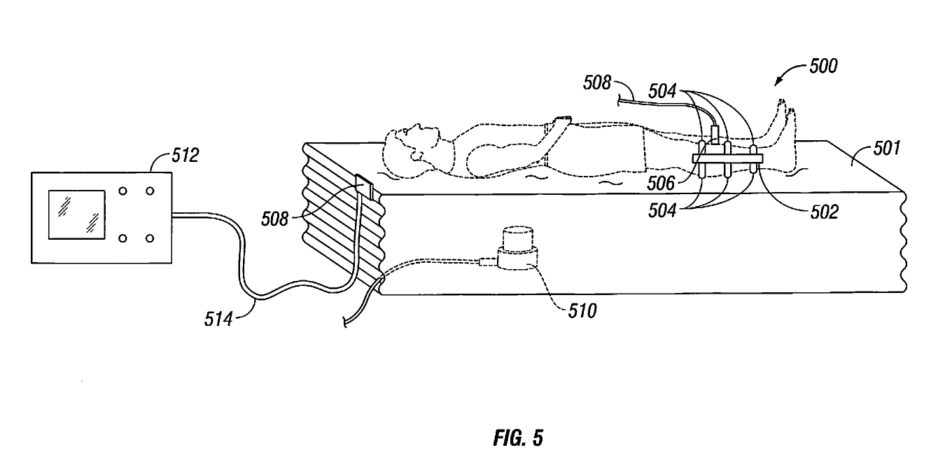

FIG. 5 illustrates a non-invasive apparatus of the present disclosure in accordance with another embodiment and is designated generally by reference numeral 500. Apparatus 500 is similar to apparatus 300 and will only be discussed in detail to the extent necessary to identify differences in construction and/or operation. In this particular embodiment, the apparatus 500 is shown mounted to a patient for generating and directing vibratory energy to the patient's right leg for vibrational treatment of bone tissue therein while the patient is laying on the vibrational bed 501. The bone tissue has undergone a bone-related medical procedure whereby fixators or pins 504 have been inserted through the skin and make contact with the tibia 502 following breakage thereof.

The apparatus 500 includes at least one energy moving device 506 which may be selected from the group consisting of speakers, air moving devices (blowers and fans) and sub-woofers, or combination thereof. The energy moving device 506 is substantially similar to the energy moving device 302 of FIG. 3. The energy moving device 506 can be mounted to the patient using straps (not shown) and includes a cord 508 for plugging the energy moving device 506 to a power source, such as an AC source (e.g., wall outlet) or a DC source (e.g. control unit powered by a battery).

Preferably, the energy moving device 506 includes a plurality of speakers positioned near the bone tissue to be treated. The plurality of speakers may generate low frequency waves in a manner described hereinabove with respect to the embodiment described with reference to FIGS. 3 and 4. Moreover, each speaker may be configured to generate waves having a frequency different from the frequencies of the waves generated by the other speakers. Accordingly, bone tissue can be subjected to a vibrational stimulus produced by waves having frequencies (delivering broadband of signals).

Moreover, an arrangement similar to the one described hereinabove with respect to the embodiment described with reference to FIGS. 1 and 2 is envisioned, wherein the patient is simultaneously undergoing vibrational treatment for treating the bone tissue using the vibrational bed 501. The vibrational bed 501 is configured to vibrate for subjecting the musculoskeletal system, including the bone tissue which has undergone the bone-related medical procedure, to a vibrational stimulus while the patient lays on the vibrational bed 501. The vibrational bed 501 includes a motorized spring system having spring supports for causing the bed to vibrate at a controlled frequency. The vibrations are generated by a motorized spring mechanism 510 located underneath the bed surface 501 and attached thereto. Accelerometer 508 is used to measure the vibrational response of the patient's musculoskeletal system to simultaneously determine postural stability of the patient, using the method described hereinabove.

As described hereinabove, the vibrational response is measured and recorded by a spectrum analyzer/computer 512 which is electrically connected to the accelerometer 508 by a cable 514.

The method of the present disclosure according to this embodiment includes all the steps described in FIG. 4, except that the patient is laying on the vibrational bed 500 capable of vibrating for producing resonant vibrations in a manner described with reference to the other embodiments described above.

FIG. 6 illustrates a non-invasive apparatus of the present disclosure in accordance with another embodiment and is designated generally by reference numeral 600. Apparatus 600 is shown mounted to a patient for generating and directing vibratory energy to the patient's left leg for vibrational treatment of bone tissue therein while the patient is mobile. Similarly to apparatuses 300 and 500, apparatus 600 includes at least one energy moving device 606 which may be selected from the group consisting of speakers, air moving devices (blowers and fans) and sub-woofers, or combination thereof. The energy moving device 606 is substantially similar to the energy moving device 302 of FIG. 3 and the energy moving device 506 of FIG. 5. The energy moving device 606 is mounted to the patient using a pair of cuffs 602, 604 and straps 608 extending from the cuffs 602, 604. The energy moving device 606 includes a cord 610 for plugging the energy moving device 606 to a power source, such as an AC source (e.g., wall outlet) or a DC source (e.g. control unit powered by a battery).

Preferably, the energy moving device 606 includes a plurality of speakers positioned near the bone tissue to be treated. The plurality of speakers may generate low frequency waves in a manner described hereinabove with respect to the embodiment described with reference to FIGS. 3-5. Moreover, each speaker may be configured to generate waves having a frequency different from the frequencies of the waves generated by the other speakers. Accordingly, bone tissue can be subjected to a vibrational stimulus produced by waves having frequencies (delivering broadband of signals).

Moreover, an arrangement similar to the one described hereinabove with respect to the embodiment described with reference to FIGS. 1 and 2 and FIG. 5 is envisioned, wherein the patient is simultaneously undergoing vibrational treatment for treating the bone tissue using the vibrational table 102 and the vibrational bed 501, respectively. In such an arrangement, the resonant vibrations generated by the vibrational table 102 or vibrational bed 501 can be used to modulate the resonant waves or vibrations generated by the energy moving device 302, 506, 606.

Further, in such an arrangement, the vibrational table 102 or vibrational bed 501 can include a fastening assembly having straps and/or other fasteners for strapping the patient to the vibrational table 102 or vibrational bed 501. For example, with reference to FIG. 6, one end of a strap of the fastening assembly can be used to strap to the patient's left leg above or about cuff 602 and the other end of the strap can be used to strap to the vibrational table 102 shown by FIG. 1, thereby effectively strapping the patient's left leg to the vibrational table 102. This may be done in a situation where the patient cannot freely position his left leg on the vibrational table 102 and apply weight to his left leg due to pain following a bone-related medical procedure. It is contemplated that only the left leg is positioned on the vibrational table 102 and the right left is positioned off the vibrational table 102.

The frequencies imparted by the energy moving devices 302, 506, 606 are in the range between 20-60 Hz (this is because muscle 2A fibers respond to frequencies in the range between 20-60 Hz) with a peak amplitude between 0.04 and 0.4 g. Preferably, the frequency of the energy moving devices 302, 506, 606 is approximately 30 Hz and the peak amplitude is 0.3 g. The vibration waves generated by the energy moving devices 302, 506, 606 are preferably sinusoidal, however other waveforms are contemplated.

Advantages provided by the methods of the present disclosure is that little or no training/learning is required of the patients; the apparatus utilized by each method is inexpensive to construct and their respective small size makes it convenient for storage and use; the frequency of vibrational loading of the standing platform can be easily adjusted to permit focused treatment on a specific bone; the amplitude of vibrational loading of the standing platform can be easily controlled from 0.05 to 0.5 g; only a short duration of treatment is required for significant effect (ten minutes per day); the methods in accordance with the embodiments described herein provide a sustained effect on postural stability while treating bone tissue, such that improved postural stability can be maintained with only weekly or twice weekly treatments; the ability to monitor postural stability in real-time during treatment using the methodology described in U.S. Pat. No. 6,607,497; and the methods can be effected while the patient is in the standing or seated position.

While the methods of the present disclosure utilize a vibrating platform or vibrational bed and at least one energy moving device, respectively, as the fundamental perturbing agents for vibrating the musculoskeletal system, including the bone tissue which has undergone a bone-related medical procedure, it is contemplated that any other apparatus or method can be employed for providing the vibrational stimulus required for vibrationally treating the bone tissue in accordance with the methodology of the present disclosure.

1. A method for treating bone tissue, said method comprising:
(a) subjecting a patient, including the bone tissue, to a vibrational stimulus for a predetermined period of time, wherein the bone tissue has undergone a medical procedure; and
(b) repeating step (a) over a predetermined treatment duration to treat the bone tissue.

2. The method according to claim 2, further comprising having the patient stand on a vibration table capable of vibrating for producing resonant vibrations, wherein the energy propagated by the resonant vibrations is primarily directed along the Z-axis of the patient's body.

3. The method according to claim 1, wherein the resonant vibrations have a frequency in the range of 1 Hz to 100 KHz.

4. The method according to claim 2, wherein the resonant vibrations have a frequency in the range of 1 Hz to 10 KHz.

5. The method according to claim 2, wherein the resonant vibrations provide the vibrational stimulus at substantially the same frequency to the bone tissue.

6. The method according to claim 1, further comprising evaluating a healing response of the bone tissue and adjusting at least one of the predetermined period of time and the predetermined treatment duration accordingly.

7. The method according to claim 1, wherein the vibrational stimulus causes the bone tissue to vibrate for producing a beneficial healing effect for the bone tissue.

8. The method according to claim 1, wherein the subjecting step comprises:
providing at least one energy moving device capable of generating waves;
focusing the generated waves towards a patient's bone for treating bone tissue.

9. A method for treating bone tissue, said method comprising:
providing at least one energy moving device capable of generating waves; and
focusing the generated waves towards a patient's bone for treating bone tissue, wherein the generated waves are focused towards the portion of the bone tissue that has undergone a medical procedure.

10. The method according to claim 9, further comprising:
(a) subjecting a patient, including the bone tissue, to a vibrational stimulus for a predetermined period of time; and
(b) repeating step (a) over a predetermined treatment duration to treat the bone tissue.

11. The method according to claim 9, wherein the at least one energy moving device generates waves having a frequency in the range of 1 Hz to 100 KHz.

12. The method according to claim 9, wherein the at least one energy moving device generates waves having a frequency in the range of 1 Hz to 10 KHz.

13. The method according to claim 9, wherein the at least one energy moving device is selected from the group consisting of speakers, air moving devices (blowers and fans), sub-woofers, and combinations thereof.

14. The method according to claim 9, wherein the at least one energy moving device is mounted to a vibrational bed.

15. The method according to claim 9, further comprising having the patient stand on a vibration table, or lay on a vibrational bed, the table or the bed being capable of vibrating for producing resonant vibrations.

16. The method according to claim 15, wherein the resonant vibrations have a frequency in the range of 1 Hz to 100 KHz.

17. The method according to claim 15, wherein the resonant vibrations have a frequency in the range of 1 Hz to 10 KHz.

18. A method for treating bone tissue, said method comprising:
(a) subjecting a patient, including the bone tissue, to vibratory energy generated by at least one energy moving device for a predetermined period of time, wherein the bone tissue has undergone a medical procedure; and
(b) repeating step (a) over a predetermined treatment duration to treat the bone tissue.

19. The method according to claim 18, wherein the at least one energy moving device is is selected from the group consisting of speakers, air moving devices (blowers and fans), sub-woofers, and combinations thereof.

20. The method according to claim 18, further comprising evaluating a healing response of the bone tissue and adjusting at least one of the predetermined period of time and the predetermined treatment duration accordingly.

21. The method according to claim 18, further comprising having the patient stand on a vibration table, or lay on a vibrational bed, the table or the bed being capable of vibrating for producing resonant vibrations.
